(19) United States
(12) Patent Application Publication
(10) Pub. No.: US 2019/0278158 A1
(43) Pub. Date: Sep. 12, 2019

(54) HEAT GENERATING BODY

(71) Applicant: KABUSHIKI KAISHA TOKAI-RIKA-DENKI-SEISAKUSHO, Aichi (JP)

(72) Inventors: Hiroki ISHIZUKA, Aichi (JP); Toshinari NAKAI, Aichi (JP)

(21) Appl. No.: 16/302,456

(22) PCT Filed: May 25, 2017
(86) PCT No.: PCT/JP2017/019633

§ 371 Date: Nov. 16, 2018

(30) Foreign Application Priority Data
Jun. 3, 2016 (JP) 2016-112063

(51) Int. Cl. G03B 17/55; H04N 5/225; H05B 3/02; H05B 3/10; H05B 3/20

(52) U.S. Cl. CPC G03B 17/55; H04N 5/225; H05B 3/20; H05B 3/10; H05B 3/02

(57) ABSTRACT

A heat generating body includes a heater unit that is integrally formed with plural placement portions and that generates heat when current is passed through the heater unit, and plural electrodes that are provided at the heater unit and that are each disposed at a different one of the plurality of placement portions to each other.

### TECHNICAL FIELD

The present invention relates to a heat generating body.

### BACKGROUND ART

Japanese Patent Application Laid-Open (JP-A) No. 2007-115610 discloses a heat generating body. The heat generating body includes a substantially U-shaped heater unit that generates heat when a current is passed through. Two electrodes that are connected to a power supply line for supplying external power to the heater unit are provided adjacently to each other on a projection portion of the heater unit. The heat generating body is provided so as to cover an outer peripheral face of a heating target in order to heat the target.

### SUMMARY OF INVENTION

### Technical Problem

However, in such heat generating bodies, it is desirable to make the projection portion of the heater unit smaller in size in cases in which the projection portion of the heater unit is provided to a small target.

In consideration of the above circumstances, an object of the present invention is to obtain a heat generating body that enables a placement portion to be made smaller in size.

### Solution to Problem

A heat generating body according to a first aspect of the present disclosure includes a heater unit that is integrally provided with plural placement portions, and that generates heat when current is passed through the heater unit, and plural electrodes that are provided at the heater unit and that are each disposed at a different one of the plural placement portions.

In the first aspect of the present disclosure, the plural electrodes provided at the heater unit are each disposed on different placement portions to each other. This enables the respective placement portions to be made smaller.

A heat generating body according to a second aspect of the present disclosure is the first aspect, wherein the placement portions are provided at an outer peripheral face of a camera.

In the second aspect of the present disclosure, the placement portions are provided at the outer peripheral face of the camera. The placement portions can therefore be provided at the outer peripheral face of the camera, even if the outer peripheral face of the camera is small.

A heat generating body according to a third aspect of the present disclosure is the second aspect, wherein the plural placement portions extend in different directions to each other from a center portion of the heater unit, and are respectively provided to plural side face portions configuring the outer peripheral face of the camera.

In the third aspect of the present disclosure, the plural placement portions of the heater unit extend in different directions to each other from the center portion of the heater unit, and are respectively provided to the side face portions configuring the outer peripheral face of the camera. This enables the occurrence of flexing between the placement portions of the heater unit to be suppressed, and enables the heater unit to be more easily affixed to the outer peripheral face of the camera.

A heat generating body according to a fourth aspect of the present disclosure is the second or the third aspect, wherein a lens hole corresponding to a lens of the camera is formed in the heater unit.

In the fourth aspect of the present disclosure, the lens hole corresponding to the lens of the camera is formed in the heater unit, thereby enabling the camera to capture images effectively through the lens.

A heat generating body according to a fifth aspect of the present disclosure is any one of the second to the fourth aspect, wherein a lens abutting portion that abuts a lens of the camera and that heats the lens is provided at the heater unit.

In the fifth aspect of the present disclosure, the lens abutting portion is provided at the heater unit, and the lens abutting portion abuts the lens of the camera and heats the lens. Namely, heat is more easily transmitted to the lens, thereby enabling ice or frost adhering to the lens to be effectively melted.

### Advantageous Effects of Invention

The heat generating body according to the first aspect of the present disclosure exhibits an excellent advantageous effect of enabling the placement portions to be made smaller in size.

The heat generating body according to the second aspect of the present disclosure exhibits an excellent advantageous effect of enabling the placement portions to be provided at the outer peripheral face of a camera, even if the outer peripheral face of the camera is small.

The heat generating body according to the third aspect of the present disclosure exhibits an excellent advantageous effect of enabling the ease of assembly of the heater unit to the camera to be improved.

The heat generating body according to the fourth aspect of the present disclosure exhibits an excellent advantageous effect of enabling the camera to capture images effectively.

The heat generating body according to the fifth aspect of the present disclosure exhibits an excellent advantageous effect of enabling the field of view of the camera to be effectively secured.

### BRIEF DESCRIPTION OF DRAWINGS

FIG. 1 is a perspective view illustrating relevant portions of a heat generating body according to a first exemplary embodiment in an opened-out state.

FIG. 2 is a perspective view illustrating a heat generating body according to the first exemplary embodiment in a state attached to a camera.

FIG. 3 is an exploded perspective view illustrating a heat generating body according to the first exemplary embodiment and a camera.

FIG. 4 is an enlarged cross-section sectioned along line A-A in FIG. 3.

FIG. 5 is an enlarged cross-section illustrating section Z in FIG. 4

FIG. 6 is an opened-out view illustrating relevant portions of a heat generating body according to a second exemplary embodiment in an opened-out state.

FIG. 7 is an opened-out view illustrating relevant portions of a heat generating body according to a third exemplary embodiment in an opened-out state.

### DESCRIPTION OF EMBODIMENTS

### First Exemplary Embodiment

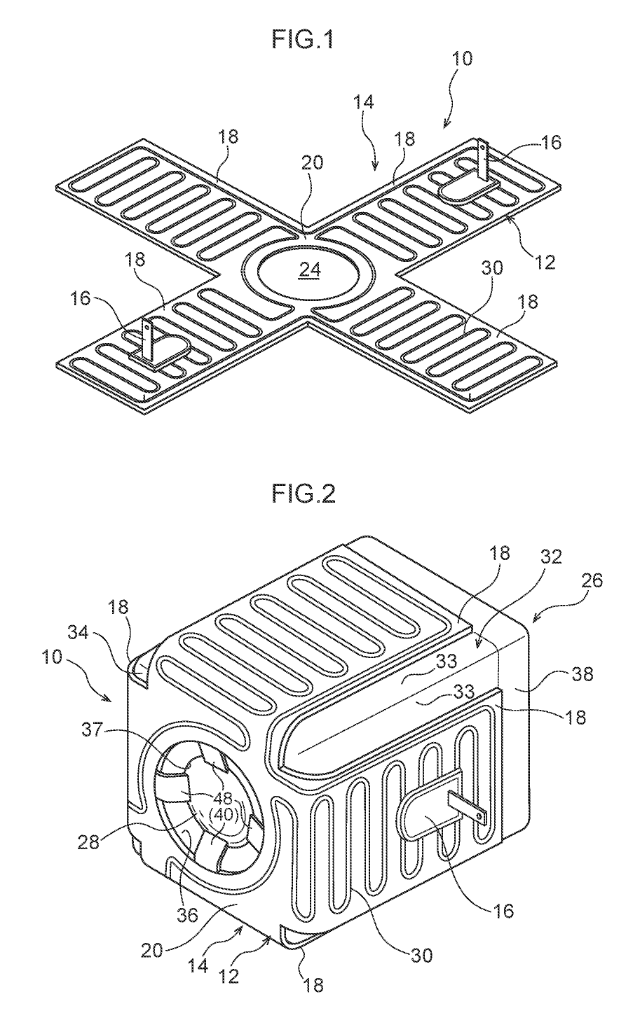

Explanation follows regarding a first exemplary embodiment of a heat generating body according to the present invention, with reference to FIG. 1 to FIG. 5.

As illustrated in FIG. 1, a heat generating body 10 (heater) is configured including a heater unit 14 and electrodes 16. The heater unit 14 is configured including a plate shaped sheet member 12, configured of an insulating, flexible material and serving as a base member, and a heat generating resistor element 30, serving as a heat generating member. Plural placement portions 18 are integrally provided at the heater unit 14, and in an opened-out state, the heater unit 14 is formed in substantially a cross shape as viewed along its plate thickness direction.

Plural (four, as an example) of the placement portions 18 are provided. The placement portions 18 extend in different directions to each other, each of these being a direction orthogonal to the plate thickness direction of the heater unit 14, such that the placement portions 18 are centered on a center portion 20 of the heater unit 14. Specifically, one placement portion 18 and another placement portion 18 opposing the one placement portion 18 across the center portion 20 are disposed so as to run along a single straight line. If this one placement portion 18 and the other placement portion 18 opposing the one placement portion 18 are considered to form a pair in combination, the heater unit 14 of the present exemplary embodiment is provided with two pairs of such combined placement portions 18. The directions in which the respective pairs of placement portions 18 oppose each other are different directions, running at substantial right angles to each other about the center portion 20.

A circular lens hole 24 is formed in the center portion 20 of the heater unit 14 so as to penetrate the heater unit 14 in the plate thickness direction. The lens hole 24 is formed in a position and with a size corresponding to a sloped portion 36 surrounding a lens 28 of a camera 26, described later (see FIG. 2).

The heater unit 14 is provided with the heat generating resistor element 30. The heat generating resistor element 30 generates heat when power is supplied to the heat generating resistor element 30 through the electrodes 16. The heat generating resistor element 30 includes portions disposed in meandering shapes on the respective placement portions 18 of the heater unit 14, and portions disposed in substantially circular arc shapes about the outer circumference of the lens hole 24 in the center portion 20 of the heater unit 14. Namely, the heat generating resistor element 30 is able to heat the respective placement portions 18 and also the periphery of the lens hole 24 of the heater unit 14.

The heater unit 14 is provided with the respective electrodes 16 on one of the placement portions 18 and on the placement portion 18 opposing the one placement portion 18. Two of the electrodes 16 are provided as an example, one electrode 16 being a positive electrode, and the other electrode 16 being a negative electrode. In other words, the electrode 16 serving as a positive electrode and the electrode 16 serving as a negative electrode are disposed on different placement portions 18 so as to be spaced apart from each other. Each electrode 16 is connected to the heat generating resistor element 30 of the heater unit 14, and a non-illustrated external power supply line is connected to each electrode 16. Thus, external power is supplied to the electrodes 16 through the power supply lines, and power is supplied to the heat generating resistor element 30 through the electrodes 16. Note that the electrodes 16 are coated with a non-illustrated encapsulating material.

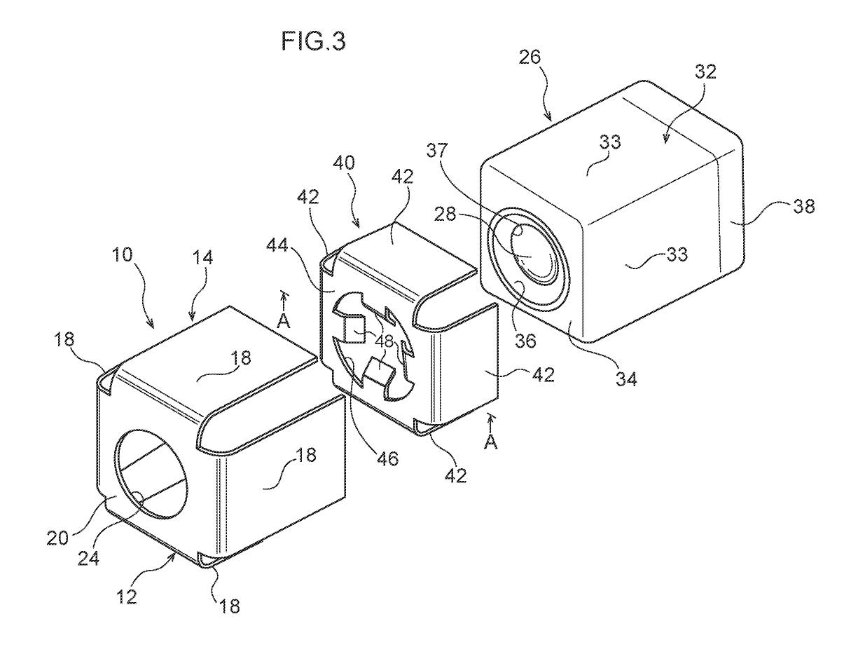

As illustrated in FIG. 2, in an attached state of the heater unit 14 to the camera 26, each of the plural placement portions 18 is bent at a substantially right angle toward the same direction with respect to the center portion 20. The bent placement portions 18 are respectively attached (affixed) to four rectangular side face portions 33 configuring an outer peripheral face 32 of the camera 26. A bottom wall portion 34 (see FIG. 3 also) is provided at one length direction end portion of the camera 26. The sloped portion 36 and a through-hole 37 are formed to the bottom wall portion 34. The sloped portion 36 is provided at the periphery of the through-hole 37, the through-hole 37 being formed in a center portion of the bottom wall portion 34 so as to penetrate the bottom wall portion 34 in its plate thickness direction. The sloped portion 36 is formed in a circular ring shape as viewed along a direction perpendicular to the surface of the bottom wall portion 34. The sloped portion 36 slopes toward the inside of the camera 26 on progression toward the center of the bottom wall portion 34.

The lens 28 is provided inside the through-hole 37 of the bottom wall portion 34. The lens 28 is attached to a non-illustrated image sensor substrate provided inside the camera 26, and the camera 26 captures images through the lens 28. A cover 38 is attached to an end portion of the camera 26 on the opposite side to the bottom wall portion 34, with non-illustrated packing interposed between the camera 26 and the cover 38 so as to restrict the ingress of water and the like into the camera 26.

As illustrated in FIG. 3, the heat generating body 10 includes a heat conducting plate 40, serving as an abutting member, provided between the heat generating body 10 and the camera 26. The heat conducting plate 40 is attached (affixed) to the heater unit 14, and is configured of a plate material made of aluminum alloy as an example. Plural (four as an example) side plate portions 42 are integrally formed to the heat conducting plate 40. Although not illustrated in the drawings, in an opened-out state, the heat conducting plate 40 is formed in substantially a cross shape as viewed along its plate thickness direction, similarly to the heater unit 14.

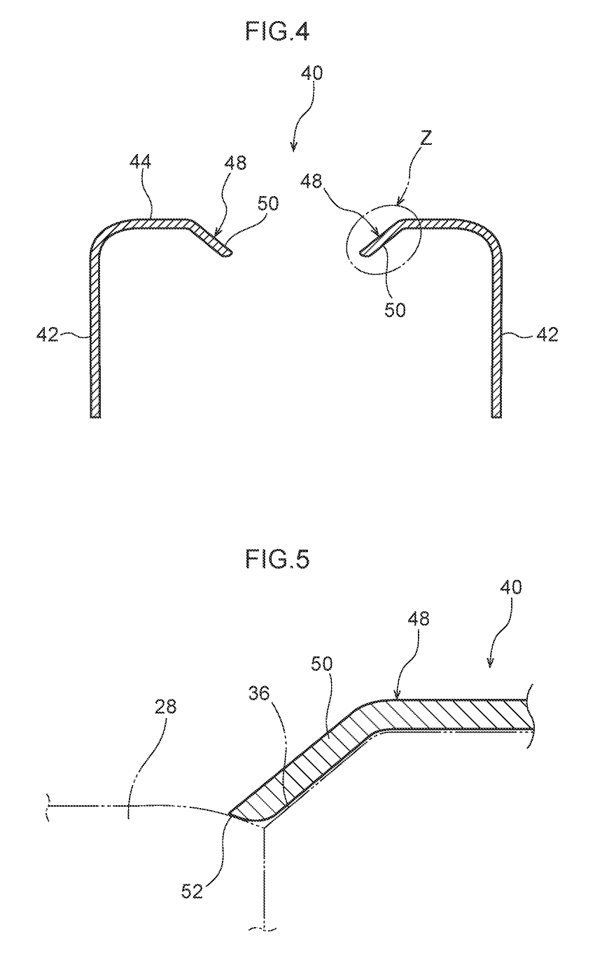

The side plate portions 42 of the heat conducting plate 40 are centered on a center portion 44 of the heat conducting plate 40 and extend partway along the placement portions 18 of the heater unit 14 in the extension directions of the respective placement portions 18. Namely, as illustrated in FIG. 4, each of the side plate portions 42 is bent at a substantially right angle toward the same direction with respect to the center portion 44 of the heat conducting plate 40.

A lens hole 46 is formed piercing through the center portion 44 of the heat conducting plate 40 in the plate thickness direction (see FIG. 3). The lens hole 46 is formed at a position corresponding to the lens 28 of the camera 26, and is set to a size that is slightly larger than the lens 28, specifically, to a size corresponding to an outer peripheral portion of the sloped portion 36 of the bottom wall portion 34 of the camera 26.

Plural lens abutting portions 48 are provided to a peripheral portion of the lens hole 46. Four lens abutting portions 48 are formed as an example. The lens abutting portions 48 are respectively provided to the lens hole 46 at positions substantially corresponding to width direction centers of the four side plate portions 42, and are disposed outside an imaging region of the lens 28 of the camera 26 (see FIG. 3). A base end portion of each lens abutting portion 48 extends toward the center of the lens hole 46 in the same plane as the center portion 44, and a leading end portion 50 of each lens abutting portion 48 is angled toward the surface of the lens 28 of the camera 26. As illustrated in FIG. 5, each leading end portion 50 extends along the sloped portion 36 of the camera 26, and a leading edge 52 of each leading end portion 50 abuts the surface of the lens 28.

Operation and Advantageous Effects of First Exemplary Embodiment

Explanation follows regarding operation and advantageous effects of the present exemplary embodiment.

As illustrated in FIG. 1, in the present exemplary embodiment, the plural electrodes 16 provided at the heater unit 14 are each disposed on a different placement portion 18 of the heater unit 14. Less space is required to dispose the electrodes 16 on respective placement portions 18 than in cases in which the plural electrodes 16 are disposed on the same placement portion 18. This enables each placement portion 18 to be made smaller.

Since the plural electrodes 16 are disposed so as to be split between different placement portions 18, the electrodes 16 are spaced apart from each other. This enables shorting due to foreign matter becoming wedged between the electrodes 16 to be suppressed.

As illustrated in FIG. 2, the placement portions 18 are provided at the side face portions 33 of the outer peripheral face 32 of the camera 26. The placement portions 18 can thus be provided at the side face portions 33 of the camera 26 even if the side face portions 33 of the camera 26 are small in size. This enables the lens 28 of the camera 26 to be heated through the outer peripheral face 32 of the camera 26, enabling ice or frost adhering to the lens 28 to be removed. This enables the camera 26 to capture images in a state in which the field of view of the camera 26 is secured, even if the camera 26 is employed in an environment where ice or frost may form.

The plural placement portions 18 of the heater unit 14 extend in different directions to each other from the center portion 20 of the heater unit 14, and are respectively affixed to the four side face portions 33 configuring the outer peripheral face 32 of the camera 26. This enables the occurrence of flexing between the placement portions 18 of the heater unit 14 to be suppressed, and enables the heater unit 14 to be more easily affixed to the outer peripheral face 32 of the camera 26. This enables the ease of assembly of the heat generating body 10 to the camera 26 to be improved.

Due to providing the heater unit 14 with the heat conducting plate 40, including the lens abutting portions 48 that abut the lens 28, heat from the heater unit 14 is transmitted to the lens 28 of the camera 26 through the lens abutting portions 48 of the heat conducting plate 40. Namely, heat is more easily transmitted to the lens 28, enabling ice or frost adhering to the lens 28 to be effectively melted. This enables the field of view of the camera 26 to be effectively secured.

The lens hole 24 is formed in the heater unit 14 so as to correspond to the lens 28 of the camera 26, and the lens hole 46 is formed in the heat conducting plate 40, thereby enabling the camera 26 to capture images effectively through the lens 28 without being obstructed by the heater unit 14 and the heat conducting plate 40. This enables the camera 26 to capture images effectively.

### Second Exemplary Embodiment

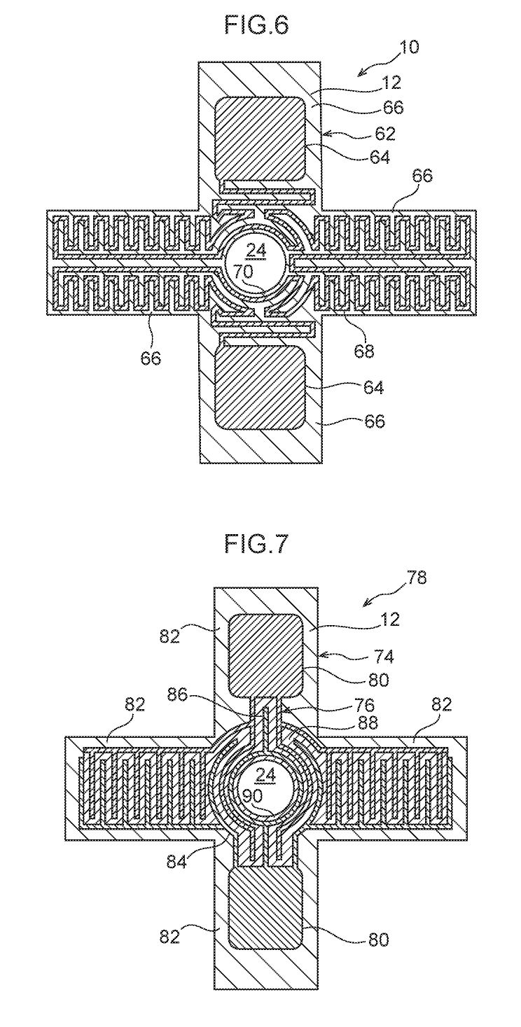

Explanation follows regarding a heat generating body according to a second exemplary embodiment of the present invention, with reference to FIG. 6. Note that configuration portions that are basically the same as those in the first exemplary embodiment described above are appended with the same reference numerals, and explanation thereof is omitted.

A heat generating body 60 according to the second exemplary embodiment has basically the same configuration as the first exemplary embodiment, but features electrodes 64 provided to end portions of a heat generating resistor element 68.

Namely, the heat generating body 60 is configured including a heater unit 62 and the electrodes 64. The heater unit 62 is configured including the plate shaped sheet member 12, configured of an insulating, flexible material and serving as a base member, and the heat generating resistor element 68, serving as a heat generating member. Plural placement portions 66 are integrally provided at the heater unit 62, and in an opened-out state as illustrated in FIG. 6, the heater unit 62 is formed in substantially a cross shape as viewed along its plate thickness direction, similarly to the heater unit 14 of the first exemplary embodiment. The circular lens hole 24 is formed in a center portion 70 of the heater unit 62, similarly to in the heater unit 14 of the first exemplary embodiment.

The heat generating resistor element 68 provided at the heater unit 62 generates heat when power is supplied to the heat generating resistor element 68 through the electrodes 64. The heat generating resistor element 68 includes portions disposed in meandering shapes on the respective placement portions 66 of the heater unit 62, and portions disposed in substantially circular arc shapes about the outer circumference of the lens hole 24 in the center portion 70 of the heater unit 62. Namely, the heat generating resistor element 68 is able to heat the respective placement portions 66 and the periphery of the lens hole 24 of the heater unit 62.

The heater unit 62 is provided with the respective electrodes 64 on one of the placement portions 66, and to the placement portion 66 opposing the one placement portion 66. Two of the electrodes 64 are provided as an example, one electrode 64 being a positive electrode, and the other electrode 64 being a negative electrode. In other words, the electrode 64 serving as a positive electrode and the electrode 64 serving as a negative electrode are disposed on different placement portions 66 so as to be spaced apart from each other. The respective electrodes 64 are integrally formed to one end portion and another end portion of the heat generating resistor element 68 of the heater unit 62.

A non-illustrated external power supply line is connected to each electrode 64. Thus, external power is supplied to the electrodes 64 through the power supply lines, and power is supplied from the electrodes 64 to the heat generating resistor element 68.

Similarly to the heater unit 14 of the first exemplary embodiment, in an attached state of the heater unit 62 to the camera 26, each of the plural placement portions 66 is bent at a substantially right angle toward the same direction with respect to the center portion 20 (see FIG. 2). The bent placement portions 66 are respectively attached (affixed) to the four rectangular side face portions 33 configuring the outer peripheral face 32 of the camera 26. Similarly to in the first exemplary embodiment, the heat generating body 60 includes a heat conducting plate 40, serving as an abutting member, provided between the heat generating body 60 and the camera 26 (see FIG. 3).

Note that the above configuration is similar to that of the heat generating body of the first exemplary embodiment, with the exception of the fact that the electrodes 64 are provided to the end portions of the heat generating resistor element 68. Accordingly, similar advantageous effects to those in the first exemplary embodiment are obtained.

### Third Exemplary Embodiment

Explanation follows regarding a heat generating body according to a third exemplary embodiment of the present invention, with reference to FIG. 7. Note that configuration portions that are basically the same as those in the first exemplary embodiment described above are appended with the same reference numerals, and explanation thereof is omitted.

A heat generating body 78 according to the third exemplary embodiment has basically the same configuration as the first exemplary embodiment, but features a Positive Temperature Coefficient (PTC) heater 76 provided to a heater unit 74.

Namely, the heat generating body 78 is configured including the heater unit 74 and electrodes 80. The heater unit 74 is configured including the plate shaped sheet member 12, configured of an insulating, flexible material and serving as a base member, and the PTC heater 76, serving as a heat generating member. Plural placement portions 82 are integrally provided at the heater unit 74, and in an opened-out state as illustrated in FIG. 7, the heater unit 74 is formed in substantially a cross shape as viewed along its plate thickness direction, similarly to the heater unit 14 of the first exemplary embodiment. The circular lens hole 24 is formed in a center portion 90 of the heater unit 74, similarly to in the heater unit 14 of the first exemplary embodiment.

The PTC heater 76 provided at the heater unit 74 is configured including a positive electrode pattern portion 84 (wiring portion), a negative electrode pattern portion 86 (wiring portion), and a heat generating element 88 (heat generating portion). The positive electrode pattern portion 84 is provided to the respective placement portions 82 of the heater unit 74, and the negative electrode pattern portion 86 is provided at an inner side of the positive electrode pattern portion 84. The positive electrode pattern portion 84 and the negative electrode pattern portion 86 are formed spaced apart from each other, and the heat generating element 88 is provided between the positive electrode pattern portion 84 and the negative electrode pattern portion 86. Note that the positive electrode pattern portion 84 and the negative electrode pattern portion 86 include portions formed in substantially circular shapes so as to run about the outer circumference of the lens hole 24 in the center portion 90 of the heater unit 74. When the electrodes 80, described later, are supplied with power, electricity flows through the heat generating element 88 disposed between the positive electrode pattern portion 84 and the negative electrode pattern portion 86, such that the heat generating element 88 generates heat. An electrical resistance value of the heat generating element 88 changes according to the temperature. Specifically, the electrical resistance value increases when the temperature rises, such that electricity flows less readily through the heat generating element 88. The heat generating body 78 thereby maintains a substantially constant temperature. The PTC heater 76 thereby enables the respective placement portions 82 and the periphery of the lens hole 24 of the heater unit 74 to be heated to a substantially constant temperature.

The heater unit 74 is provided with the electrodes 80 on one placement portion 82, and to the placement portion 82 opposing the one placement portion 82. Two electrodes 80 are provided as an example, one of the electrodes 80 being formed integrally to the positive electrode pattern portion 84, and the other electrode 80 being formed integrally to the negative electrode pattern portion 86. In other words, the electrode 80 serving as a positive electrode and the electrode 80 serving as a negative electrode are disposed on different placement portions 82 so as to be spaced apart from each other.

A non-illustrated external power supply line is connected to each electrode 80. Thus, external power is supplied to the electrodes 80 through the power supply lines, and power is supplied from the electrodes 80 to the positive electrode pattern portion 84 and the negative electrode pattern portion 86.

Similarly to the heater unit 14 of the first exemplary embodiment, in an attached state of the heater unit 74 to the camera 26, each of the plural placement portions 82 is bent at a substantially right angle toward the same direction with respect to the center portion 20 (see FIG. 2). The bent placement portions 82 are respectively attached (affixed) to the four rectangular side face portions 33 configuring the outer peripheral face 32 of the camera 26. Similarly to in the first exemplary embodiment, the heat generating body 78 includes a heat conducting plate 40, serving as an abutting member, provided between the heat generating body 78 and the camera 26 (see FIG. 3).

Note that the above configuration is similar to that of the heat generating body of the first exemplary embodiment, with the exception of the fact that the PTC heater 76 is provided at the heater unit 74. Accordingly, similar advantageous effects to those in the first exemplary embodiment are obtained.

Since the PTC heater 76 is provided at the heater unit 74, when current passes through the PTC heater 76 and the temperature of the PTC heater 76 rises, the electrical resistance value increases such that electricity flows less readily. Thus, the heater unit 74 maintains a substantially constant temperature and the amount of power consumed is kept constant, enabling power consumption to be reduced.

Note that the first to third exemplary embodiments described above are configured such that the two electrodes 16, 64, 80 are respectively disposed on one placement portion 18, 66, 82, and another placement portion 18, 66, 82 that opposes the one placement portion 18, 66, 82, of the heater unit 14, 62, 74. However, there is no limitation thereto, and the respective electrodes 16, 64, 80 may be disposed on adjacent placement portions 18, 66, 82.

Moreover, although the camera 26 is formed in a substantially rectangular tube shape by the four side face portions 33, there is no limitation thereto. The camera 26 may be formed in a polygonal tube shape configured by three, or five or more, side face portions 33. In accordance therewith, there is no limitation to configuring the heater unit 14, 62, 74 with four placement portions 18, 66, 82 as in the first to third exemplary embodiments. The heater unit 14, 62, 74 may be configured including three or fewer, or five or more, placement portions 18, 66, 82, so as to correspond to the shape of the camera 26.

Although the heater unit 14, 62, 74 is provided with the heat conducting plate 40 including the lens abutting portions 48, there is no limitation thereto, and the lens abutting portions 48 may be formed to the heater unit 14, 62, 74 itself.

Exemplary embodiments of the present invention have been explained above; however, the present invention is not limited to the above embodiments, and various other modifications may obviously be implemented within a range not departing from the spirit of the present invention.

The entire disclosure of Japanese Patent Application No. 2016-112063, filed Jun. 3, 2016 is incorporated by reference in this specification.

1.-8. (canceled)

9. A heat generating body comprising:
a heater unit that is integrally provided with a plurality of placement portions, and that generates heat when current is passed through the heater unit; and
a plurality of electrodes that are provided at the heater unit and that are each disposed at a different one of the plurality of placement portions,
the plurality of placement portions being respectively provided at different faces of an outer peripheral face of a camera.

10. The heat generating body of claim 9, wherein the plurality of placement portions extend in different directions with respect to each other from a center portion of the heater unit, and are respectively provided to a plurality of side face portions configuring the outer peripheral face of the camera.

11. The heat generating body of claim 9, wherein a lens hole corresponding to a lens of the camera is formed in the heater unit.

12. The heat generating body of claim 9, wherein a lens abutting portion that abuts a lens of the camera and that heats the lens is provided at the heater unit.

13. The heat generating body of claim 9, wherein:
the heater unit includes a heat generating resistor element; and
the electrodes are provided to end portions of the heat generating resistor element.

14. The heat generating body of claim 9, wherein the heater unit includes a PTC heater.

15. The heat generating body of claim 14, wherein the PTC heater includes a positive electrode pattern portion, a negative electrode pattern portion, and a heat generating element.
